(19) United States
(12) Patent Application Publication
(10) Pub. No.: US 2025/0315744 A1
(43) Pub. Date: Oct. 9, 2025

(54) Agent Management System and Agent Management Method

(71) Applicant: Hitachi, Ltd., Chiyoda-ku, Tokyo (JP)

(72) Inventors: Shinji ISHIHARA, Tokyo (JP); Ryu NARIKAWA, Tokyo (JP); Masaki KANAI, Tokyo (JP); Kazuya SUGIMOTO, Tokyo (JP); Tadashi KOTANI, Tokyo (JP)

(21) Appl. No.: 18/866,873

(22) PCT Filed: Apr. 26, 2023
(86) PCT No.: PCT/JP2023/016419

§ 371 Date: Nov. 18, 2024

(30) Foreign Application Priority Data
May 25, 2022 (JP) 2022-085010

(51) Int. Cl. G06Q 10/047; G05D 1/698; G05D 101/00; G05D 105/28; G05D 107/70; G06Q 10/087

(52) U.S. Cl. CPC G06Q 10/047; G05D 1/6987; G06Q 10/087; G05D 2101/22; G05D 2105/28; G05D 2107/70

(57) ABSTRACT

Provided are an agent management system and method capable of calculating, in real time, a route plan for efficiently moving a large number of agents. This agent management system is characterized by comprising agents that can move within a management area, and local calculation units that determine movement routes for moving the agents from initial positions to target positions, wherein the management area is divided into a plurality of control areas, and wherein each local calculation unit is provided for a respective control area, determines a movement route for the agents within the control area, and assigns the movement route to these agents.

### TECHNICAL FIELD

The present invention relates to an agent management system and an agent management method for planning a moving route in an area in the presence of a plurality of agents of various types.

### BACKGROUND ART

Introduction of mobile robots (AGV: Auto100ted Guided Vehicle, AMR: Autonomous Mobile Robot, and the like) has been in progress to solve the problem of labor shortage for article transport in the logistics warehouse, and inter-process transport in the factory.

Introduction of the above-described mobile robots requires setting of passages (preparing a graph composed of nodal points (nodes) and branches (branches/edges)) in the warehouse and factory to make the robots movable. As the setting becomes more detailed, the degree of freedom in setting of the passage selectable by the robot becomes higher. This attains more efficient transport. On the contrary, such setting requires more manhour. Setting of the passage is required to adapt every change in the layout of the warehouse or the factory. Accordingly, the detailed passage setting imposes a heavy load (engineering cost) on the business operator for managing the warehouse and the factory.

Aiming at solving the above-described problem, Patent Literature 1 discloses the method for calculating the route along which a plurality of robots (vehicles in Patent Literature 1) move without designing the passage in detail.

More specifically, control inputs (speed, angular speed) with respect to each robot are calculated in accordance with the concept of the model predictive control to minimize the distance between the current position and the target position of each robot without bringing the respective robots in contact with an obstacle (pillar and wall in the building, other robots). The calculated control inputs are integrated to provide the moving route (position, posture).

### CITATION LIST

### Patent Literature

Patent Literature 1: Japanese Unexamined Patent Application Publication No. 2021-77090

### SUMMARY OF INVENTION

### Technical Problem

According to Patent Literature 1, it is possible to calculate the route that allows the robot to reach the target position without preliminarily designing detailed information of passages in the warehouse and the factory. As the moving plan is calculated in a time series while considering dynamics of all the robots, it is possible to form more efficient moving plan than the one derived from the exclusive control system for controlling to prevent entrance of a plurality of robots into the same space.

Patent Literature 1 solves an optimization problem utilizing the dynamics obtained by gathering all the robots existing in the target area. Upon formulation of the optimization problem, it is known that the calculation load sharply increases as the increase in the number of robots. Application of the method as disclosed in Patent Literature 1 to the area in the presence of many robots takes an enormous amount of time. Therefore, it is predicted to have difficulties in forming the robot moving plan.

The present invention has been made to solve the above-described problem. It is an object of the present invention to provide an agent management system and an agent management method for attaining real time calculation of the route plan that allows efficient movement of many agents (robot, vehicle, automobile).

### Solution to Problem

In light of the circumstances, the present invention provides “the agent management system including an agent movable in a management area, and a local computing section for determining a moving route for movement of the agent from an initial position to a target position. The management area is divided into a plurality of control areas, and the local computing section is placed for each of the divided control areas for determining the moving route to be given to the agent in the control area”.

In light of the circumstances, the present invention provides “the agent management method for determining a moving route for movement of an agent movable in a management area from an initial position to a target position. The management area is divided into a plurality of control areas, and a local computing section placed for each of the divided control areas determines the moving route for the agent in the control area, and gives the moving route to the agent”.

### Advantageous Effects of Invention

The present invention allows calculation of the moving route to attain efficient movement in a short calculation period while preventing contact among many agents.

### BRIEF DESCRIPTION OF DRAWINGS

FIG. 1 shows an example of a structure of an agent management system according to an embodiment of the present invention.

FIG. 2 shows an example of a structure of a management area exemplified as a logistics warehouse.

FIG. 3a shows an example of a structure of a calculator system which constitutes a management section and a local computing section.

FIG. 3b shows an example of a structure of a calculator system which constitutes a management section and a local computing section.

FIG. 3c shows an example of a structure of a calculator system which constitutes a management section and a local computing section.

FIG. 4a shows a mobile robot as an example of an agent.

FIG. 4b shows an example of a structure of a state detection unit of the agent.

FIG. 4c shows an example of a structure of a route following unit of the agent.

FIG. 5 shows an example of a structure of a route planning unit of the agent.

FIG. 6a shows an example of map information about a control area 100A as shown in FIG. 2.

FIG. 6b shows an example that a current position and a target position of the agent are superposed on the map information as shown in FIG. 6a.

FIG. 6c shows an example of a wide area route obtained by utilizing a Dijkstra method.

FIG. 7a shows an example of a method for determining a virtual target position of a single unit of agent.

FIG. 7b shows an example of a method for determining a virtual target position of a single unit of agent.

FIG. 7c shows an example of a corrected wide area route to be calculated for the single unit of agent.

FIG. 8 is an explanatory view of a condition for preventing the contact between two agents.

FIG. 9 shows an example according to an embodiment in which a management area is divided into control areas.

FIG. 10 shows a condition that demands movement while straddling the control area.

FIG. 11a shows map information obtained by integrating two control areas.

FIG. 11b shows a route of a control area 100B specified by a local computing section S1.

FIG. 11c shows a route of a control area 100B specified by a local computing section S2.

FIG. 11d shows a finally determined overall route.

FIG. 12a shows another finally determined overall route.

FIG. 12b shows another route of the control area 100B specified by a local computing section S2.

FIG. 13a shows processing to be executed in the case of many areas divided from the management area.

FIG. 13b shows processing to be executed in the case of many areas divided from the management area.

FIG. 13c shows processing to be executed in the case of many areas divided from the management area.

FIG. 14 is a flowchart representing the content of processing to be executed by a route planning system.

FIG. 15 shows an example of a structure of the management area exemplified as a parking lot.

FIG. 16 shows an example of a method for obtaining divided control areas from the parking lot as a target management area.

FIG. 17a shows an example of a route plan to be formed upon application of the present invention to the parking lot.

FIG. 17b shows an example of a route plan to be formed upon application of the present invention to the parking lot.

FIG. 17c shows an example of a route plan to be formed upon application of the present invention to the parking lot.

### DESCRIPTION OF EMBODIMENTS

An agent management system calculates moving plans (timelines such as coordinates, postures, and speeds) of all agents (controllable mobile bodies such as robots and vehicles) in a management area (for example, warehouse and parking lot), and manages so that the agents follow the route plan. Embodiments of the agent management system according to the present invention are described referring to the drawings.

### First Embodiment

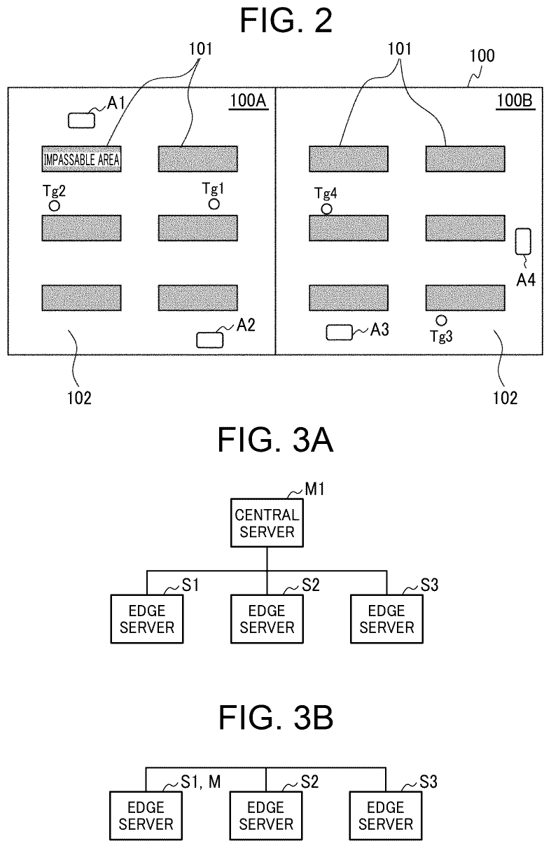

FIG. 2 shows an example of a structure of a management area exemplified as a logistics warehouse. The embodiment of the present invention is described as below on the assumption of the circumstance that four agents A (A1 to A4) exist and move in a management area 100 as shown in FIG. 2.

As FIG. 2 shows, the management area 100 is divided into two control areas 100A and 100B. Four agents A (A1 to A4) are movable freely from current positions to target positions Tg (Tg1 to Tg4), respectively on a passage area 102 except impassable areas 101 such as shelfs and pillars. It is assumed that the management area 100 to which the present invention is applicable is divided into a plurality of control areas. Other conditions, however, may be arbitrarily determined.

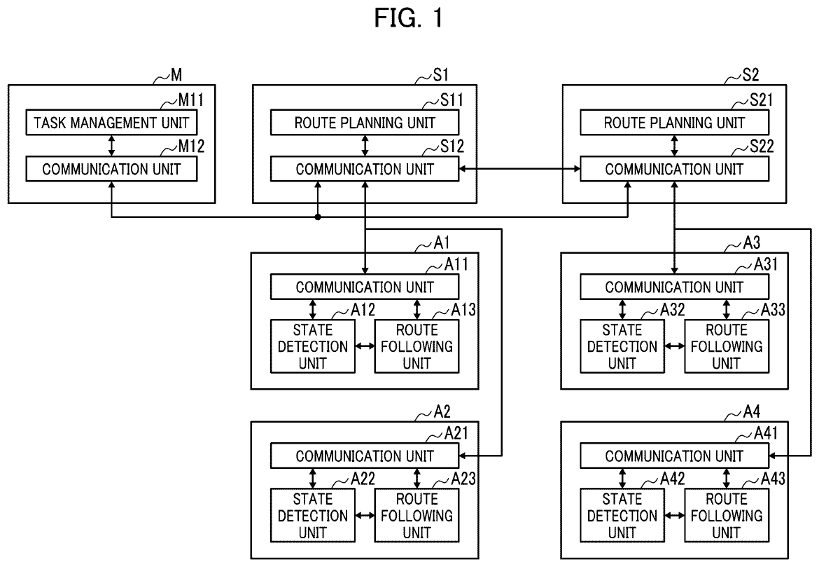

FIG. 1 shows an example of a structure of an agent management system according to an embodiment of the present invention. The agent management system includes a management section M, a plurality of local computing sections S (S1, S2), and one or more agents A (A1 to A4) managed by the local computing sections S. The number of the local computing sections S (S1, S2) is the same as the divided number (the number of control areas) of the management area 100. The local computing section S1 manages the agents A1, A2 in the control area 100A, and the local computing section S2 manages the agents A3, A4 in the control area 100B.

Constituent sections of the agent management system as shown in FIG. 1 are described as below. Firstly, the management section M includes functions of a task management unit M11 and a communication unit M12. The task management unit M11 manages tasks of the agents A (A1 to A4) in the management area 100. The task refers to a series of operations to be performed by the robot in the logistics warehouse including, for example, collection of an article stored in the specific shelf, and transport of the article to a delivery area. The present invention, however, deals only with a part of operations of the task, specifically, movement of the robots from arbitrary initial positions to arbitrary target positions Tg (Tg1 to Tg4), respectively. The task management unit M11 is only required to have at least a function for calculating the target positions Tg with respect to current positions of the respective agents A. Referring to FIG. 2, a numerical value as a suffix attached to the code of the agent A is the same as a numerical value as a suffix attached to the corresponding target position Tg. Specifically, for example, the target position of the agent A1 is expressed as Tg1.

The communication unit M12 has a function for transmitting the target position Tg calculated by the task management unit M11 to the local computing section S (S1, S2). The communication unit M12 communicates with communication units S12, S22 of the respective local computing sections S (S1, S2) to allow collection of the current positions of the agents A in the management area 100.

The local computing section S (S1, S2) as shown in FIG. 1 is described. The local computing sections S (S1, S2) are constituted by the communication units S12, S22 and the route planning units S11, S21, respectively. The local computing sections S (S1, S2) communicate with the communication unit M12 of the management section M, and the communication units A11, A21, A31, A41 of the agents A via the communication units S12, S22, respectively. The local computing sections S (S1, S2) communicate with each other.

The communication channel structure allows the local computing sections S (S1, S2) to transmit current positions of the respective agents A to the management section M. The management section M then acquires task information of the respective agents A. The route planning units S11, S21 perform route planning for executing the task designated by the management section M, and transmit the planned routes to the respective agents A managed by the local computing sections S (S1, S2), respectively.

The local computing sections share the load and duty with respect to the divided control areas 100A, 100B shown in FIG. 2 so that the local computing section S1 performs route planning for the agents A1, A2 in the control area 100A, and the local computing section S2 performs route planning for the agents A3, A4 in the control area 100B.

Referring to FIG. 1, the management section M is not directly communicable with communication units of the agents A (A1 to A4). However, it is possible to provide a structure that allows direct communication.

The use of calculator (server) allows implementation of the management section M and a plurality of local computing sections S (S1, S2) shown in FIG. 1. The calculator system that allows such implementation may be configured in various forms.

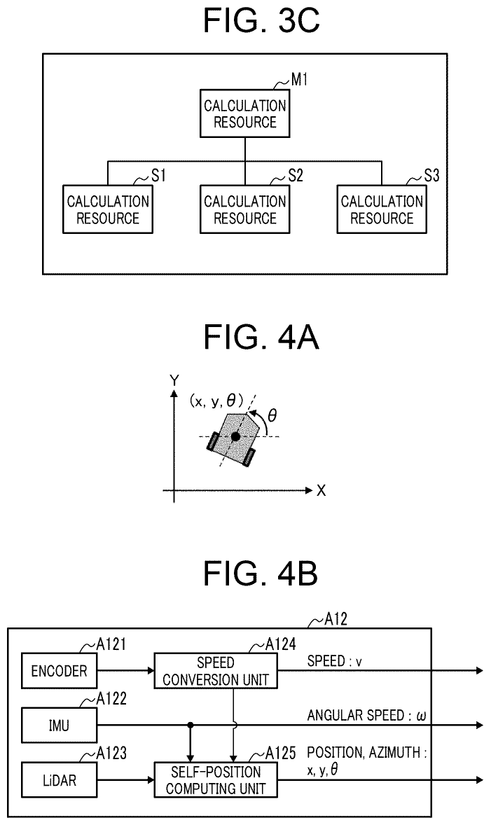

The management section M expected to manage overall operations of the management area 100 may be configured to be installed in a central server, that is, constituted by a leader (management section M) and followers (a plurality of local computing sections S (S1, S2)) as shown in FIG. 3a.

As FIG. 3b shows, it is also possible to arrange a single unit of an edge server installed with functions of both the management section M and the local computing section S1, and an edge server installed with the function of local computing section S1 in the same row without using the central server. Referring to the configuration as shown in FIG. 3b, the function of the management section M may be transferred to another edge server at the specific time. In the above-described configuration, if a failure occurs in the specific edge server, operations of the control area covered by such server can only be stopped. This may avoid interruption of overall operations of the management area.

If the single server is provided with a plurality of calculation resources (for example, CPU), it is possible to allocate functions of the management section M and the computing section S1 to each calculation resource so long as a plurality of calculation resources (for example, CPU) are provided in the single server. This configuration is applicable to the multi-core personal computer by assigning each core with processing to be executed by the management section and the local computing section.

Referring back to FIG. 1, an explanation is made with respect to the agents A (A1 to A4). Basically, each of those agents A has the same structure. The agents A include communication units A11, A21, A31, A41, state detection units A12, A22, A32, A42, and route following units A13, A23, A33, A43, respectively.

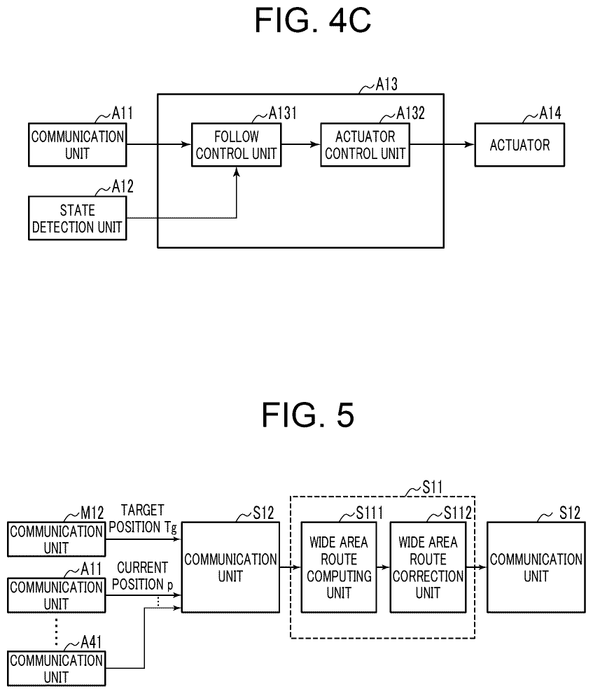

The agent A may be a mobile robot installed with the above-described functions as shown in FIG. 4a. In the management area 100 expressed by two-dimensional coordinates (X-Y coordinates), the position control including the posture (angle θ) of the mobile robot is executed to allow the mobile robot to move to the target position Tg. The respective sections of the agent A will be described in detail. As each of agents A has the same structure, the following description is basically made with respect to the agent A1 as a representative example unless otherwise required for making a distinction.

The communication unit A11 (A21, A31, A41) corresponds to a terminal that allows wireless communication with Bluetooth and Wi-Fi.

The state detection unit A12 (A22, A32, A42) as shown in FIG. 4b corresponds to sensors for acquiring the agent state (position, speed), and to the computing function in accordance with the sensor output. Assuming that the agent A is a wheeled robot as shown in FIG. 4a, the state detection unit A12, A22, A32, or A42 is provided with sensors such as an encoder A121, an inertia sensor A122 (IMU: Inertia Measurement Unit), and a LiDAR A123 (Light Detection And Ranging). As the sensor structure differs by the type of the agent (robot, automobile), those sensors do not have to be necessarily provided.

The use of the rotation speed of the axle, and the wheel diameter, which have been detected by the encoder A121 allows a speed conversion unit A124 to calculate the moving speed v of the vehicle robot. Detection results from the sensors of the encoder A121, the inertia sensor A122, and the LiDAR A123 are integrated (sensor fusion) by a self-position computing unit A125 to allow calculation of a position (x, y) and an azimuth (θ) of the vehicle robot. The angular speed ω is derived from the inertia sensor A122.

As the self-position computing unit A125 may be implemented by the technology known as SLAM (Simultaneous Localization and Mapping), the detailed explanation of such unit is omitted.

Various data which are acquired by the state detection unit A12, or calculated may be timely expanded to the communication unit A11 and the route following unit A13 (in a predetermined cycle or upon reception of the request).

Referring to FIG. 4c, the route following unit A13 has a function for controlling operations of the agent A to follow the route plan received via the communication unit A11. The route following unit A13 includes a follow control unit A131 and an actuator control unit A132.

In accordance with the route plan which has been received via the communication unit A11, that is, a vector as unified information relating to the target route, r(t)=[xr(t)yr(t)θr(t)] (t: time), and a state p of the agent, which has been received from the state detection unit A12, p(t)=[x(t)y(t)θ(t)], the follow control unit A131 executes a feedback control to reduce the difference between the target route r(t) and the state p(t).

A control value calculated by the follow control unit A13 differs by structure of the agent. For example, in the case of the differential two-wheeled robot as shown in FIG. 4a, rotation speeds of the left and right wheels become control values. In the case of the automobile, a steering amount and acceleration/deceleration (accelerator, brake application amount) become the control value.

The actuator control unit A132 has a function for controlling the actuator to attain the control value calculated by the follow control unit A131. In the case of the differential two-wheeled robot, an electric motor for driving the left and right wheels corresponds to the actuator. The actuator control unit corresponds to the function for executing the speed control to attain the desired rotation number of the electric motor.

As described above, the route planning system of the present invention includes the local computing sections S for the control areas 100A, 100B, respectively, which have been divided from the management area 100. If the management area 100 is divided into two control areas 100A and 100B as shown in FIG. 2, two units of the local computing sections S1 and S2 are used. The local computing sections S1, S2 perform route planning for the control areas 100A, 100B, correspondingly.

As described above, the local computing section S may be implemented by individual calculators (server, computer), or by different calculation resources on the single unit of calculator. It is possible to allocate the local computing sections S1 and S2 to different CPUs of the same calculator. In the above-configured embodiment, if it is possible to access the same memory region from the different CPUs, it can be considered that the respective local computing sections perform communication via the communication unit S12.

The management section M may be installed in the same calculator so long as the function arrangement does not cause the local computing section S to increase its processing load. For example, the management section M and the local computing section S may be implemented on the single unit of calculator. The above-described configuration is required to prevent processing of the management section M from influencing the calculation resource of the control section S.

The calculator provided with functions of the management section M and the local computing section S as described above is collectively referred to as a route planning device.

The route planning units S11, S12 mainly serving as the route planning device perform route planning for the agents A (A1 to A4) in the control areas 100A, 100B, respectively. Each of the agents A (A1 to A4) is allowed to calculate its own position by the state detection unit A12. It is determined as to which control area the subject agent is positioned, 100A or 100B in accordance with the calculated position information, and communication is performed with the local computing section S1 or S2 of the corresponding control area 100A or 100B. For example, if the control areas are in the condition as shown in FIG. 2, the agents A1, A2 communicate with the local computing section S1, and the agents A3, A4 communicate with the local computing section S2.

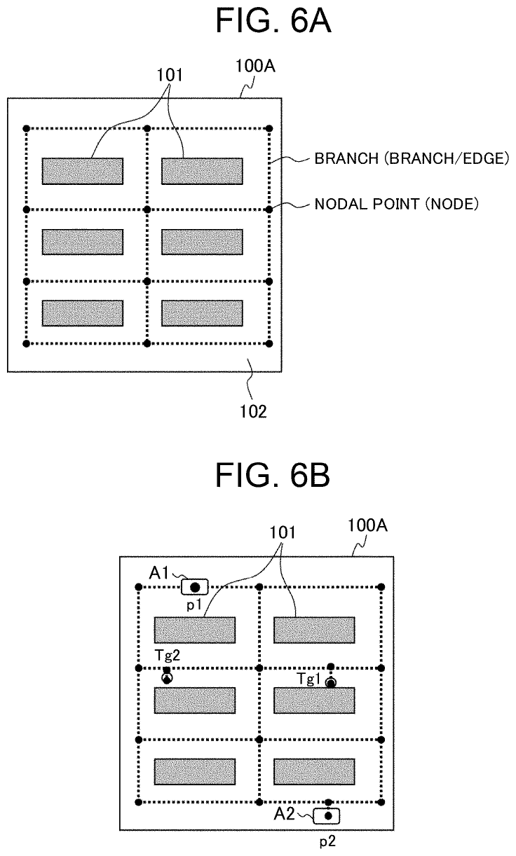

As FIG. 5 shows, the route planning unit S11 includes a wide area route computing unit S111 and a wide area route correction unit S112. The wide area route generation unit S111 calculates the wide area route for each of the agents A through the graph-based search method such as a Dijkstra method.

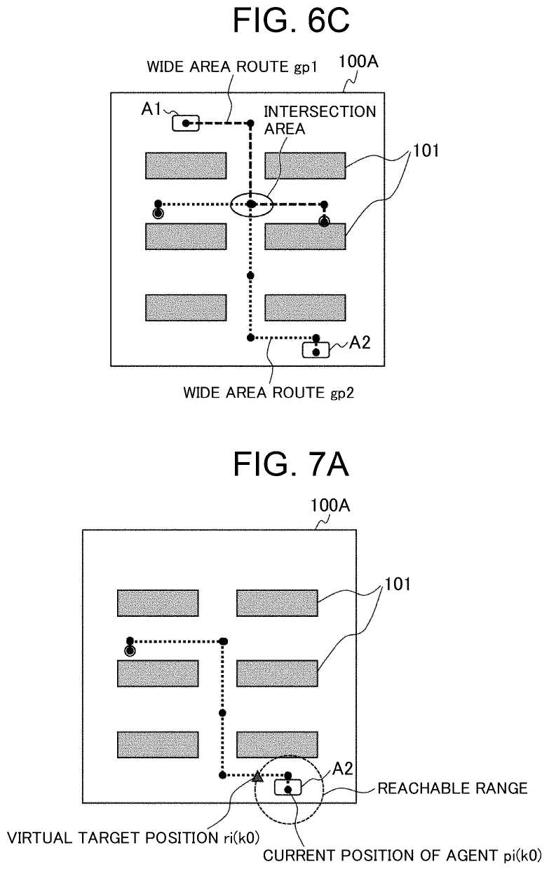

Referring to FIGS. 6a, 6b, 6c, a method for generating the wide area route by the wide area route generation unit S111 is described. FIG. 6a shows an example of the map information with respect to the control area 100A as shown in FIG. 2. In this example, branches (branches/edges) are prepared to pass through the center of the passage area 102 except the impassable area 101 in the target control area 100A. A nodal point (node) is set at each intersection between the respective edges.

FIG. 6b is a view obtained by superposing current positions p1, p2 and the target positions Tg1, Tg2 of the agents A1, A2, respectively on the map information as shown in FIG. 6a. Nodes are added to the current positions p1, p2 of the agents A1, A2. Nodes are further added to positions on the edge of the map information, each of which is closest to the node added to the current positions p1, p2 of the agents A1, A2. An edge for connecting the nodes is generated.

The preparatory process allows generation of wide area routes gp1, gp2 as shown in FIG. 6c by utilizing, for example, the Dijkstra method. As the wide area routes gp1, gp2 are only data that store coordinates (x, y), they do not determine the specific timing (time) at which the agents pass through the respective coordinates.

The drawing shows an intersection between the two wide area routes gp1 and gp2. The use of the route generated by the wide area route generation unit S111 may cause a collision between the agents A1 and A2. In order to solve such problem, the wide area route correction unit S112 performs route planning in consideration of the timing at which the agent passes through each route.

In spite of the advantageous effect of easy availability of the simple map, a small number of edges and nodes may fail to generate the efficient moving route.

The present invention solves the problem by utilizing the wide area route correction unit S112.

An explanation is made with respect to implementation of the function of the wide area route correction unit S112 by executing the model prediction control. The following explanation is made based on the definition of a formula (1) having pi as a vector that contains the position and azimuth of the i-th agent Ai, ri as the position of the i-th agent Ai on the wide area route gpi, which has been calculated by the wide area route generation unit S111 (hereinafter referred to as a “virtual target position”), and ei as a deviation between the vector and the position. In the formula, the term k denotes a calculation step (time). Besides a target position Tgi, the information on the coordinates (x, y) is only available for the wide area route gpi. Accordingly, the azimuth θr of the intermediate position is set to an arbitrary value.

$$[ Math . 1 ]$$

$$\begin{matrix}{p}_{i} ( k ) = {[ \begin{matrix}{x}_{i} ( k ) & {y}_{i} ( k ) & {θ}_{i} ( k )\end{matrix} ]}^{T} \\ {r}_{i} ( k ) = {[ \begin{matrix}{xr}_{i} ( k ) & {yr}_{i} ( k ) & θ {r}_{i} ( k )\end{matrix} ]}^{T} \\ {e}_{i} ( k ) \text{:} \text{=} {p}_{i} ( k ) - {r}_{i} ( k )\end{matrix} \} \qquad ( 1 )$$

The following explanations are made on the assumption that each of the agents A is operated in accordance with a motion equation as a formula (2) for simplifying the description. The speed vi and the angular speed ωi correspond to the control command values which are calculated by the follow control unit A131 of the route following unit A13.

$$[ Math . 2 ]$$

$$\begin{matrix}\frac{{dp}_{i}}{dt} = \frac{d}{dt} [ \begin{matrix}{x}_{i} \\ {y}_{i} \\ {θ}_{i}\end{matrix} ] = [ \begin{matrix}{v}_{i} cos {θ}_{i} \\ {v}_{i} sin {θ}_{i} \\ {ω}_{i}\end{matrix} ] \\ = f ( {p}_{i} , {u}_{i} )\end{matrix} \qquad ( 2 )$$

A formula (3) defines a control command vector ui that unifies the speed vi and the angular speed ωi of the i-th agent Ai. A formula (4) is derived from discretization of the formula (2) at a sampling interval Δt.

$$[ Math . 3 ]$$

$${u}_{i} ( k ) = {[ \begin{matrix}{v}_{i} & {ω}_{i}\end{matrix} ]}^{T} \qquad ( 3 )$$

$$[ Math . 4 ]$$

$${p}_{i} ( k + 1 ) = {p}_{i} ( k ) + Δ t \cdot f ( {p}_{i} ( k ) , {u}_{i} ( k ) ) \qquad ( 4 )$$

The wide area route correction unit S112 calculates the command vector ui(k) to reduce the deviation ei(k) between the position pi(k) of each agent and a virtual target position ri(k) on the wide area route gpi at each time k without causing collision among a plurality of agents.

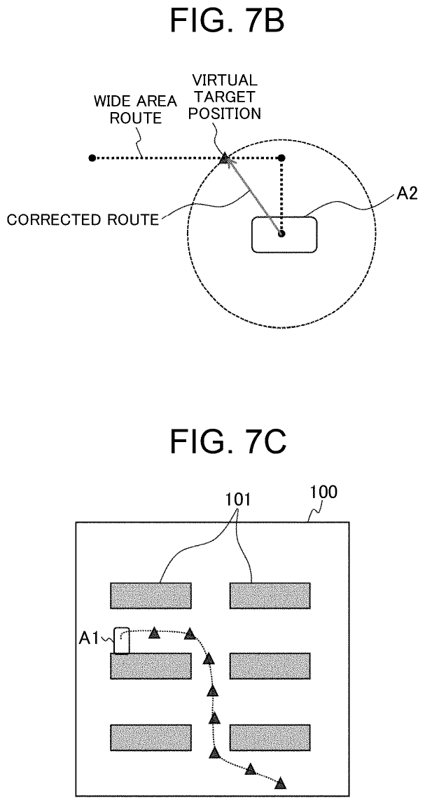

The method for determining the virtual target position ri(k) in the case of the single agent is described with reference to FIGS. 7a and 7b. For simplifying the description, an explanation is made with respect to the exemplary case where only one unit of the second agent A2 exists.

In the embodiment, the virtual target position ri is set as a specific point on a wide area route rgi in the range reachable by the agent in an arbitrary time. A final value of the virtual target position ri has to be computed to match a final value of the target position Tgi on the wide area route.

Determined is the range reachable by the robot after an elapse of the arbitrary period of time from the current position pi(k0) of the agent as a starting point. It is assumed that a circle with a radius a is given as the reachable range for simplifying the description.

It is assumed that an intersection between the radius a and the wide area route rgi is set to the virtual target position ri(k0), taking the current position pi(k0) of the agent as a center. It is possible to calculate a point expressed by a black triangle in FIG. 7a as the virtual target position ri(k0).

When the virtual target position ri(k0) is specified, an evaluation function Ji can be formulated as a formula (5) in a model prediction control operation that allows movement from the current position pi(k0) to the virtual target position ri(k0).

$$[ Math . 5 ]$$

$${J}_{i} = {\sum }_{k = {k}_{0}}^{Np - {k}_{0} + 1} {( {r}_{í} ( {k}_{0} ) - {p}_{i} ( k ) )}^{T} {Q}_{i} ( {r}_{i} ( {k}_{0} ) - {p}_{i} ( k ) ) + {u}_{i}^{T} {R}_{i} {u}_{i} \qquad ( 5 )$$

Each of terms Qi and Ri denotes a weight matrix, and a term Np denotes a prediction step. The agent position pi(k) in the formula (5) is updated by calculating (predicting) a future agent position from the current time k0 in accordance with the formula (4). Detailed explanations of the formula (5) are omitted as it is formulated from the general model prediction control.

The model prediction control calculates an optimum control input ui(k) to minimize the evaluation function Ji at each time k. The route, consequently, is not directly calculated. The acquired optimum control input ui(k) is substituted in the formula (4) to allow calculation of positions x(k), y(k), and the azimuth θ(k) of the agent at each time. This makes it possible to generate time series data (data up to Np steps forward from the time k0) of the calculated position and azimuth.

The use of the model prediction control as expressed by the formula (5) allows the agent to calculate the shortest route to the virtual target position ri(k0) as indicated by FIG. 7b so long as there is no possibility of collision between the agent and the obstacle. The computing operation is repeatedly performed every time the agent position is changed. Accordingly, the virtual target position ri(k) is corrected as indicated by FIG. 7c. The wide area route calculated by the wide area route computing unit S111 is corrected to a more efficient moving route by the wide area route correction unit S112.

The route from the initial position pi(k0) to the target position Tgi as indicated by FIG. 7c may be generated only in the case of sufficiently long prediction step Np. As the prediction step Np is made longer, the time for computing the model prediction control is prolonged. For the purpose of performing route planning in real time, it is preferable to perform computing repeatedly by taking the agent position pi(k) acquired in each predetermined cycle as the initial position pi(k0) rather than calculating the route from the initial position pi(k0) to the target position Tgi collectively.

When calculating the virtual target position utilizing the above-described method, if the radius a is set to a small value, a track of the corrected route calculated by the wide area route correction unit S112 matches the wide area route rgi. Accordingly, this method may be less contributable to improvement in the moving efficiency.

The method for determining each route planning for the a plurality of agents is described. Explanations have been made with respect to the operation of the wide area route correction unit S112 in the case of the single agent. Explained below is the operation of the wide area route correction unit S112 in the case of a plurality of units (N units) of agents.

The method similar to the one for the single unit of agent is utilized to calculate the current position pi(k) and the virtual target position ri(k0) of each unit of the agents. If N units of agents exist in a control area 101A, the use of the formula (6) allows formulation of the evaluation function J for movement of all the N units of agents from the current positions to the virtual target positions, respectively.

$$[ Math . 6 ]$$

$$J = {{\sum }_{i = 1}}^{N} {J}_{i} = {{\sum }_{i = 1}}^{N} {\sum }_{k = {k}_{0}}^{Np - {k}_{0} + 1} {( {r}_{í} ( {k}_{0} ) - {p}_{i} ( k ) )}^{T} {Q}_{i} ( {r}_{i} ( {k}_{0} ) - {p}_{i} ( k ) ) + {u}_{i}^{T} {R}_{i} {u}_{i} \qquad ( 6 )$$

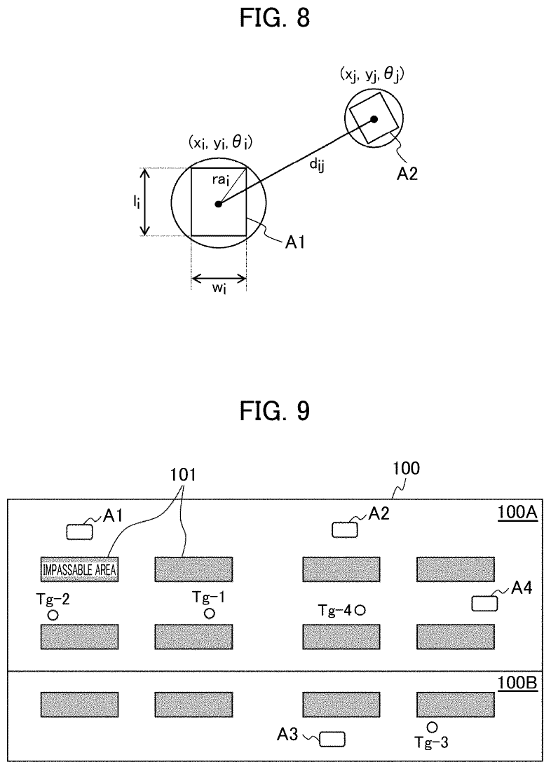

The a plurality of agents existing in the control area 101A may collide with one another. It is therefore necessary to add a condition that prevents contact among those agents. As FIG. 8 shows, assuming that the i-th agent has its width wi and length li, the agent can be enclosed by a circle with a radius rai as expressed by the formula (7). The use of a formula (8) allows calculation of a distance dij between center coordinates of the i-th agent and the j-th agent. Establishment of the constraint condition as expressed by a formula (9) indicates that the contact between the i-th agent and the j-th agent does not occur.

$$[ Math . 7 ]$$

$${ra}_{i} = \sqrt{{( {w}_{i} / 2 )}^{2} + {( {l}_{i} / 2 )}^{2}} \qquad ( 7 )$$

$$[ Math . 8 ]$$

$${d}_{ij} = \sqrt{{( {x}_{i} - {x}_{j} )}^{2} + {( {y}_{í} - {y}_{j} )}^{2}} \qquad ( 8 )$$

$$[ Math . 9 ]$$

$${d}_{ij} > {r}_{i} + {r}_{j} \qquad ( 9 )$$

The efficient moving route may be calculated without causing collision between the agents by obtaining the control input string U(k)=[u1(k) . . . uN(k)] for minimizing the formula (6) in the constraint condition expressed by the formula (9).

Processing of the local computing sections S1, S2 in the control areas 100A, 100B allows route planning to attain highly efficient movement of the agents A while preventing collision in the overall management area 100.

In the present invention, the management area 100 is divided into the control areas 100A, 100B to which independent local computing sections S1, S2 (calculation resources) are allocated, respectively. The problem may be simplified by performing the optimization calculation for agents A (two units as shown in FIG. 2) in the control areas 100A, 100B without performing the optimization calculation for agents A (four units as shown in FIG. 2) in the overall management area 100. This makes it possible to attain both optimality and reduction in the calculation time.

The above-described method is implemented based on the fact that the optimization result of the overall management area 100 matches the total sum of the respective optimization results of the control areas 100A, 100B if there is no interference occurs between the agents in the control areas 100A and 100B. In order to constantly secure the optimality, preferably, the task management unit M11 of the management section M assigns the task not to straddle the control areas 100A and 100B.

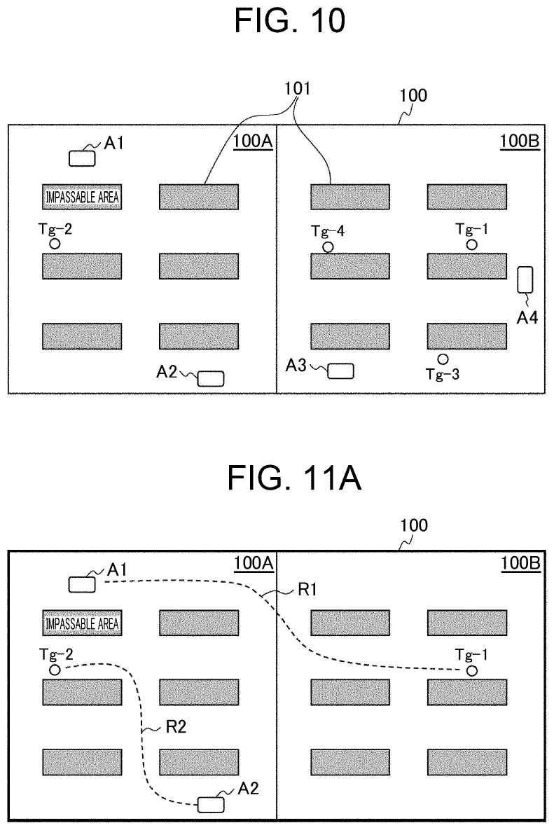

As FIG. 2 illustrates, the management area 100 is designed to be equally divided into the control areas 100A and 100B, each area of which becomes the same. The process for division into the control areas, however, is not limited to the one as described in the present invention. The condition required for the division into the control areas 100A, 100B may be satisfied if the number of agents A existing in the control areas 100A, 100B does not exceed the number of calculation resources of the local computing sections S1, S2. For example, if the upper limit value of the number of agents A which can be processed by the local computing sections S1, S2 is three, it is possible to utilize the method for division into control areas each having the different area as shown in FIG. 9. It is also possible to arbitrarily change the control areas 100A, 100B during system operation so long as there is no physical constraint such as the effective range of the network connection (wave reaching range in the wireless communication).

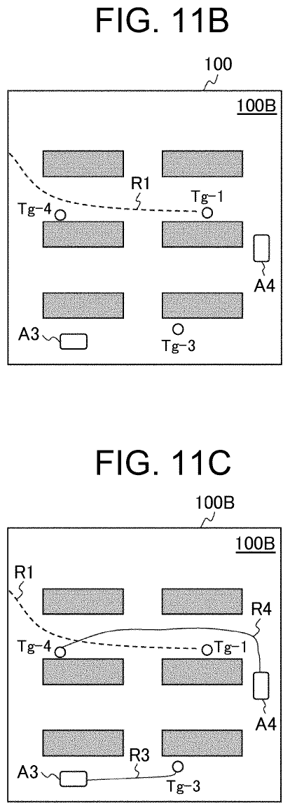

The above-described operations have been performed on the assumption that all the agents A execute their tasks in the same control areas 100A, 100B, respectively. If division into the control areas 100A, 100B cannot be changed by reason of network connection, there may be the task that indispensably requires straddling of the control areas 100A, 100B. For example, if the task demanding to move to the shelf (target position Tg1) at the right end in the management area 100 is assigned to the agent A1 as shown in FIG. 10, the agent A1 has to move from the control area 100A to the control area 100B.

In the circumstances as described above, it is possible to solve the optimization problem in consideration of the condition that prevents collision between the agents existing either in the control area 100A or 100B. However, it is still difficult to avoid the collision between the agents during straddling of the control areas 100A and 100B. The solution for the above-described problem is described below.

If the task of straddling the control areas 100A, 100B is generated, the task management unit M11 of the management section M confirms connection in the control area ranging from the control area in the presence of the agent A assigned with the task to the control area in the presence of the target position Tg. In an arrangement example as shown in FIG. 10, the current position exists in the control area 100A, and the target position Tg1 exists in the control area 100B. The connection route between those positions extends from the inside of the control area 100A directly to the control area 100B.

Upon generation of the task of straddling the control areas, the task management unit M11 of the management section M provides a computing priority to each local computing section S to preferentially calculate the route plan for the control area in the presence of the agent at the initial position, which straddles the control areas.

In the condition as shown in FIG. 10, the route plan formed by the local computing section S1 for the control area 100A is calculated with priority higher than the route plan to be formed by the local computing section S2 for the control area 100B.

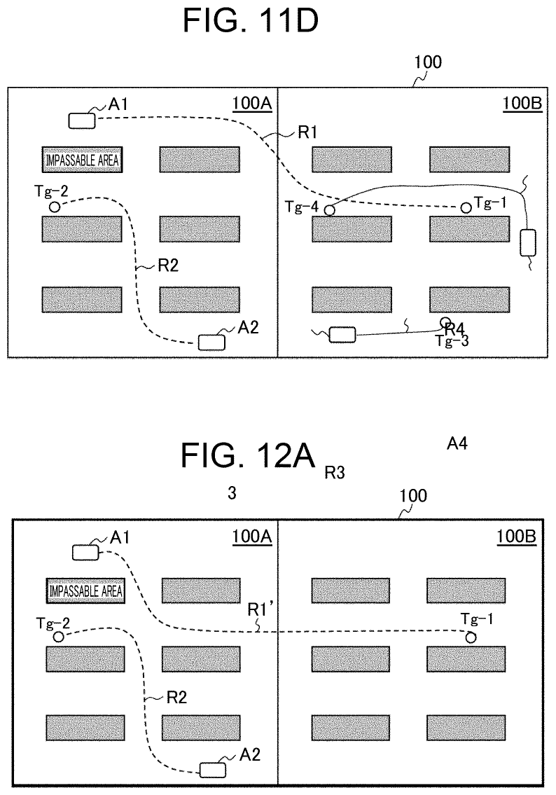

Referring to FIGS. 11a, 11b, 11c, 11d, the specific route planning flow is described. If the control areas 100A and 100B are adjacent to each other, the local computing section S1 for managing the agent A1 in the control area 100A calculates route plans R1, R2 for two agents A1, A2 in the control area 100A with respect to the map information derived from integrating the two control areas 100A, 100B as shown in FIG. 11a. Upon route planning in this case, movements of the two agents A1, A2 in the control area 100A are only considered. Meanwhile, agents A3, A4 existing in the control area 100B as shown in FIG. 2 are not considered.

The local computing section S1 supplies the route R1 for the agent A1 to the local computing section S2 for controlling the adjacent control area 100B. FIG. 11b shows the supplied route. As FIG. 11c shows, the local computing section S2 for managing and controlling the control area 100B calculates route plans R3, R4 for two agents A3, A4, respectively in the control area 100B while considering the received route R1 for the agent A1. The route planning is performed in restricted conditions that operations of the agents A3, A4 in the control area 100B follow the preferentially specified route R1 for the agent A1 (the route is kept unchanged).

The processing described above may be expressed by a formula (10). The local computing section S1 for the control area 100A calculates a control input u for minimizing the evaluation function of the formula (10) with respect to agents i=1, 2 in the constraint condition (d12>r1+r2).

$$[ Math . 10 ]$$

$${min}_{U} J Subject to \begin{matrix}J = {\sum }_{i = 1}^{2} {J}_{i} \\ {d}_{12} > {r}_{1} + {r}_{2}\end{matrix} \} \qquad ( 10 )$$

Meanwhile, the optimization problem to be treated by the local computing unit S2 in the control area 100B may be formulated by a formula (11). Among three agents co-existing in the control area 100B, the agent A1 is regarded as a known obstacle by a formula (11). Considering the constraint conditions (d14>r1+r4) (d13>r1+r3) for avoiding the obstacle, the optimization control problem is solved using the evaluation function J relating to two agents i=3, 4, and the constraint condition (d34>r3+r4).

$$[ Math . 11 ]$$

$${min}_{U} J Subject to \begin{matrix}J = {\sum }_{i = 3}^{4} {J}_{i} \\ {d}_{34} > {r}_{3} + {r}_{4} \\ {d}_{14} > {r}_{1} + {r}_{4} \\ {d}_{13} > {r}_{1} + {r}_{3}\end{matrix} \} \qquad ( 11 )$$

The local computing section S2 does not treat the movement of the agent A1 as a control variable (optimization parameter). The processing allows both the local computing sections S1 and S2 to solve the optimization problems only of two agents. It is therefore possible to reduce the calculation time.

FIG. 11d shows finally obtained route plans R1, R2, R3, R4, which have been planned for all the agents A1, A2, A3, A4, respectively in all the control areas.

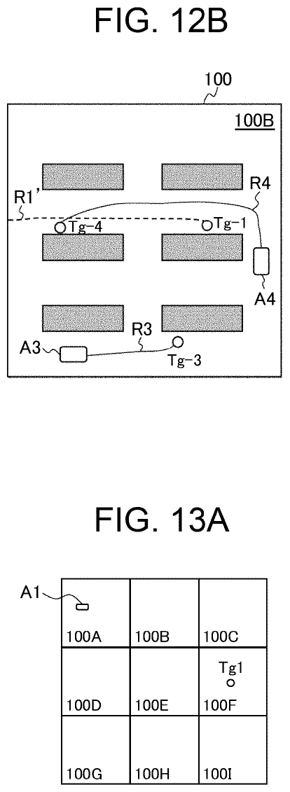

FIGS. 12a, 12b show a route plan R1′ for the agent A1, which is formed to move substantially parallel to the passage around the boundary between the control areas 100A and 100B.

In the condition as shown in FIG. 10, the route length of the route R1 for the agent A1 as shown in FIG. 11a becomes substantially the same as the route length of the route R1′ as shown in FIG. 12a. The route as shown in FIG. 11a guides the agent to move obliquely with respect to the boundary between the control areas in transition of the control area. There is a possibility of a following error which occurs when the agent is actually subjected to the route following control by the route following unit A13. The following error which is not considered in route planning may cause interference between the agents. Meanwhile, the following error hardly occurs since the route formed as shown in FIG. 12a does not change operations between before and after the transition of the control area. Provision of the route as described above suppresses possible interference between the agents in the control area 100B.

The description has been made on the premise that the route from the initial position to the target position Tg is formed for an expansion control area 100 as shown in FIG. 11a. A large prediction step Np has to be designed for forming the above-described route. This needs lots of calculation time. The prediction step Np is then reduced to periodically recalculate the route plan. If the current position of the agent A1 enters the control area 100B, and the computing section S2 for the control area 100B performs the optimization calculation for three agents, it is preferable to allow the computing section S2 to perform the respective route planning for three agents A1, A3, A4 subsequently.

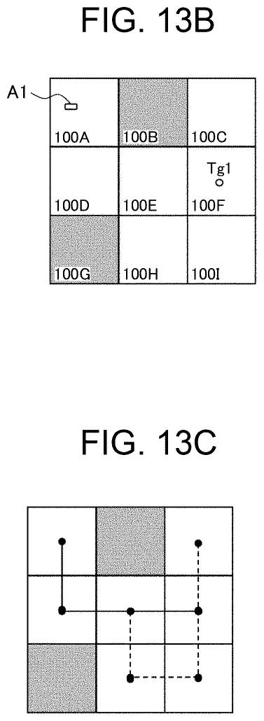

The case of dividing the management area into many areas is described referring to FIGS. 13a, 13b, 13c. Referring to FIGS. 13a, 13b, 13c, the similar processing is executed in the case of many areas divided from the management area. As FIG. 13a shows, the management area 100 is divided into nine control areas from 100A to 100I.

FIG. 13a shows an assumed condition that the target position Tg1 of the agent A1 in the control area 100A is set to be in a control area 100F. In other words, the starting point is set in the control area 100A, and the target point is set in the control area 100F. In this condition, the task management unit M11 of the management section M calculates the shortest route that connects the control areas 100A and 100F.

Upon calculation of the shortest route, passability is determined by considering the computable upper limit value of the number of agents, which is determined by the throughput of the computing section S corresponding to each of the respective control areas.

It is assumed that the upper limit number of agents which can be handled by the computing section S already exist in gray-colored control areas 100B and 100G as shown in FIG. 13b. In this case, the management section M calculates the shortest route that connects the control areas 100A to 100F while bypassing the control area 100B in the order of “100A→100D→100E→100F”. The shortest route as described above can be easily searched by the graph-based approach as indicated by FIG. 13c. More specifically, the route may be searched using the graph having no nodes set in the control areas (100B, 100G) where many agents exist.

Upon completion of searching of the shortest route, the expansion control area is changed from “100A-100D”, “100D-100E”, “100E-100F” sequentially in accordance with the current position of the agent moving in the control areas. This allows execution of the processing in the manner similar to the case where two control areas are adjacent to each other as described above.

An explanation has been made on the assumed case where one unit of the agent which straddles the control areas exists only in one control area. Even in the case where a plurality of agents which straddle the control areas exist in a plurality of control areas, execution of the similar processing allows movement to the adjacent area. In this condition, however, the management section M is required to give a priority by determining as to which agent is to be moved preferentially. Such prioritization may be made simply in the order from the small ID allocated to the agent, or in the order from the longer moving distance of the agent (distance from the current position to the target position).

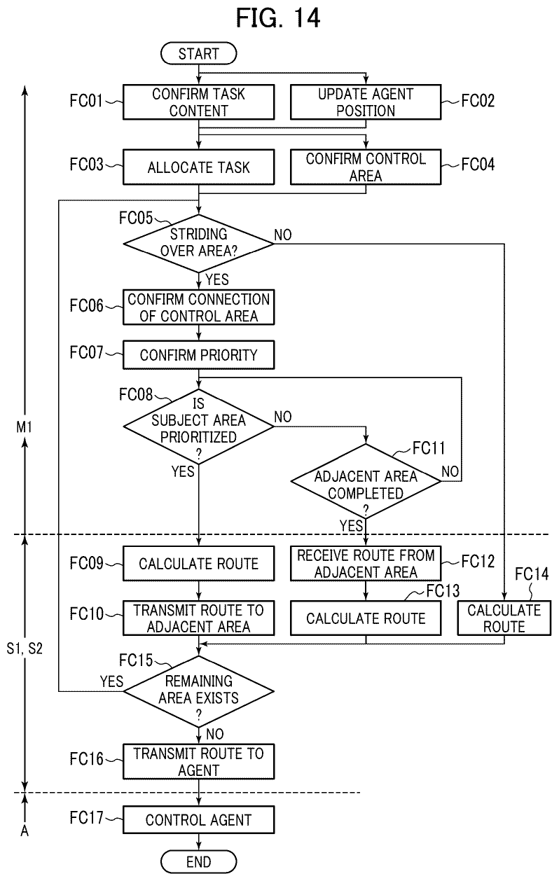

FIG. 14 is a flowchart representing processing functions executed by the route planning system. Among processing functions FC, the management section M executes functions from FC01 to FC08, and FC11. The local computing section S executes functions FC09, FC10, and from FC12 to FC16. The agent A executes the function FC17.

Upon execution of a series of processing operations, in the processing function FC01, the task management unit M11 confirms work contents (task).

In the processing function FC02, the communication unit M12 of the management section M communicates with the respective local computing sections S1, S2 for collecting each position information of the agents A (A1-A4) in the overall management area 100. As described above, the position information may be collected by direct communication between the management section M and each of the agents A. Priority of processing function to be given to either FC01 or FC02 does not have to be specified so long as execution of each processing of the functions is completed before the process proceeds to the subsequent processing.

In the processing function FC03, the task management unit M11 determines target positions Tg (Tg1-Tg4) of the agents A (A1-A4), respectively, based on their current positions and task contents (destination).

In the processing function FC04, the task management unit M11 determines the control areas 100A, 100B based on the agents A (A1-A4) which have been communicated with the communication units S12, S22 of the respective local computing sections S1, S2. The priority of processing to be given to either FC03 or FC04 does not have to be specified as well.

In the processing function FC05, it is determined whether there is any of the agents A (A1-A4) required to move while straddling the control areas 100A, 100B based on correlations between destinations of the respective agents A (A1-A4), and the control areas 100A, 100B, which have been determined by the processing function FC04. The processing function FC05 is executed by the task management unit M11.

A series of processing operations from the processing functions FC05 to FC15 are then executed in the respective control areas 100A, 100B.

If it is determined by the processing function EC05 that the agent required to move while straddling the areas exists (Yes), the process proceeds to the processing function FC06. If it is determined that the agent required to move while straddling the area does not exist (No), the process proceeds to the processing function FC14. If the work is ideally designed (movement that needs straddling of the control areas does not occur), the process is expected to always proceed to the processing function FC14.

The process proceeds to the processing function FC14 to solve the optimization problem for each area using the formulae (6) and (9) so that the route planning is performed for the agent. Upon completion of execution of the processing function FC14, the process proceeds to the processing function FC15 to be described later.

When the process proceeds to the processing function FC06, confirmation is made with respect to connection between areas for the agent required to move from the initial position to the target position while straddling the areas.

The processing function FC07 determines the priority order of the control area for calculating the route in accordance with the connection between the control areas 100A and 100B. Each processing operation executed by the processing functions FC06 and FC07 corresponds to the one to be executed by the management section M as shown in FIG. 10.

The processing function FC08 confirms the processing priority order of the target control area in the loop processing to be executed in the processing functions from FC05 to FC15. If the priority given to the target control area is higher than the one given to the adjacent control area (YES), the process proceeds to the processing function FC09. Meanwhile, if the priority given to the target control area is lower than the one given to the adjacent control area (NO), the process proceeds to the processing function FC11. The above-described branching allows calculation of the route for the control area from the higher priority order.

The processing function FC09 executes the route planning for the control area with high priority order. This processing operation corresponds to the route planning for the extension control area as shown in FIGS. 11b and 11d. The processing operation is executed by the route planning unit S1.

Upon completion of the route planning, the processing function FC10 transmits the calculated route plan to the adjacent area. This processing is executed by the communication unit S12 of the local computing section S1. When the processing functions FC09 and FC10 finish the route planning for the control area with higher priority order, the process proceeds to the processing function FC15.

The processing function FC15 confirms whether there is any control area having its route planning incompleted. If there is the control area having its route planning incompleted (YES), the process returns to the processing function FC05. If route planning for all the control areas has been completed (NO), the process proceeds to the processing function FC16.

If NO is selected at the conditional branch of the processing function FC08, that is, the agent moves from the adjacent control area, the processing function FC11 is executed. The processing function FC11 confirms with respect to completion of the route calculation (processing function FC09) for the control area with priority higher than the one given to the target control area. If the route calculation for the control area with higher priority (processing function FC09) has been incompleted (NO), an index i is changed. The process then proceeds to the processing function FC08. If the route calculation for the control area with higher priority (processing function FC09) has been completed (YES), the process proceeds to the processing function FC12.

In the processing function FC12, the control area prioritized in the processing function FC10 receives the calculated route plan for the agent. This processing is executed by the communication unit in the local computing section (for example, S2) which is different from the communication unit in the local computing section S (for example, S1) for executing the processing function FC10.

In the processing function FC13, the route planning for the agent is performed utilizing the optimization problem (formula (11)) having the agent regarded as the obstacle in the route plan received in the processing function FC12.

When the processing functions FC12 and FC13 finish the route planning for the control area with lower priority order, the process proceeds to the processing function FC15.

When the process proceeds to the processing function FC16, the route planning for all agents in all the control areas is completed. Accordingly, the respective computing sections deliver the route plans to the agents.

The processing function FC17 controls the route following unit A3 with respect to the route plan received by each agent to start moving.

### Second Embodiment

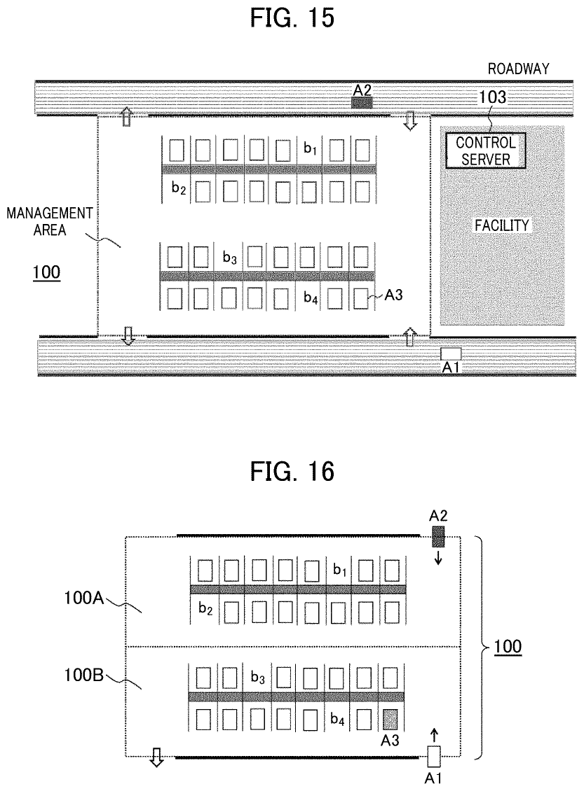

A second embodiment describes a specific example that the present invention is applied to the route planning with respect to a parking lot. FIG. 15 shows an example of a structure of the management area exemplified as a parking lot.

It is assumed that a target parking lot (management area) is exemplified as the one for a facility, which is interposed between two roadways, and has gateways to the parking lot from the respective driveways. It is also assumed that an automobile (agent A) using the parking lot according to the embodiment is exemplified as an autonomous driving vehicle with communication function, and a CAV (Connected Autonomous Vehicle).

The overall parking lot corresponds to the management area 100 according to the present invention. The agent A (CAV) which enters the parking lot (management area) communicates with a control server 103 (having functions of the management section M and a plurality of local computing sections S), and moves to the parking space in accordance with the route plan given by the control server 103.

The control server 103 manages empty spaces bi (b1 to b4 in the illustrated example) in the parking lot, and guides each entering vehicle to the empty space bi. The control server further guides the vehicle leaving the parking lot to the driveway. The control server 103 is placed in the facility as shown in FIG. 15. However, it may be placed at an arbitrary location so long as it is communicable with the management area 100.

The structure using the single unit of control server 103 corresponds to the structure as shown in FIG. 3c. However, the structure may be arbitrarily formed besides the one as illustrated in FIG. 3.

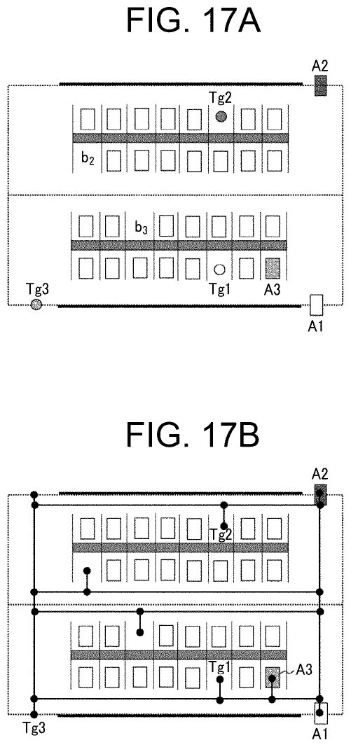

FIG. 16 shows an example of a method for dividing the target parking lot into control areas. Operations of the route planning system are described referring to FIG. 16 representing the condition that agents A1, A2 enter the parking lot, and an agent A3 is about to leave the parking lot through an exit at a lower side. The description of this example is made on the assumption that the management area 100 is divided into two control areas 101A and 101B, both of which are fixed.

The agents A1, A2 entering the management area 100 start communicating with the control server 103. The agent A3 starts communication with the control server 103 when a user finishes riding in the vehicle, or starts leaving.

The task management section M1 installed in the control server 103 determines the target position Tgi in accordance with a positional relationship among current positions of the agents A, the empty spaces bi, and exits.

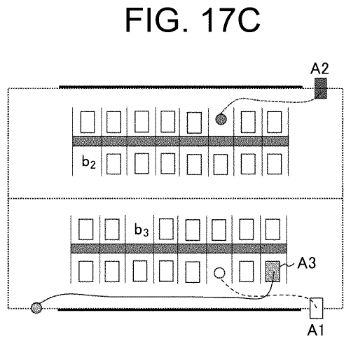

In the condition as indicated by FIG. 16, the empty space that makes the moving distance from the entry position shortest is set as the target position as shown in FIG. 17a. Specifically, the target position Tg1 of the agent A1 is set to the empty space b4, the target position Tg2 of the agent A2 is set to the empty space b1, and the target position Tg3 of the agent A is set to the exit of the parking lot.

The map information (graph) of the parking lot in the condition as indicated by FIG. 17a is generated as FIG. 17b shows. Like the information with respect to the logistics warehouse as shown in FIG. 6a, edges are placed at the center of the passage in the parking lot, and nodes are set at the respective intersections. Nodes are further added to the empty spaces, and the node is set at the intersection with the nearest edge. This makes it possible to automatically generate the map.

The wide area route generated using the graph shown in FIG. 17b allows easy route planning as FIG. 17c shows by executing the same process as the one executed in the case of the logistics warehouse.

Embodiments of the present invention have been described as exemplified as the logistics warehouse and the parking lot. It is clearly understood that the case to which the present invention is applied is not limited to those described above. For example, the present invention is applicable to generation of moving route for a conveying vehicle in a port area, and the route for a robot moving in a theme park.

### LIST OF REFERENCE SIGNS

A (A1 to A4): agent
A11, A21, A31, A41: communication unit
A12, A22, A32, A42: state detection unit
A13, A23, A33, A43: route following unit
M: management section
M11: task management section
M12: communication unit
S (S1, S2): local computing section
S11, S21: route planning unit
S12, S22: communication unit
S111: wide area route computing unit
S112: wide area route correction unit

1. An agent management system including an agent movable in a management area, and a local computing section for determining a moving route for movement of the agent from an initial position to a target position, wherein
the management area is divided into a plurality of control areas, and the local computing section is placed for each of the divided control areas for determining the moving route to be given to the agent in the control area.

2. The agent management system according to claim 1, wherein:
the agent includes a detection unit for acquiring a value of state quantity of its own, a control section for controlling the agent using the state quantity acquired by the detection unit, and a route following unit for controlling a position of the agent, which has been acquired by the detection unit in accordance with the moving route from the agent; and
the local computing section performs a route computing operation for the agent in a target control area to make an evaluation that becomes higher as a position of the agent moved forward by arbitrary steps from a present time makes a closer approach to the target position.

3. The agent management system according to claim 1, having an initial position of the agent and a target position of the agent located in the different control areas, wherein:
among a plurality of local computing sections, a first local computing section for managing the initial position sets an integrated control area for integrating all control areas from the initial position to the target position, determines a moving route for each of all the agents in the control area of the integrated control area, which is managed by the first local computing section, sets the moving route from the initial position to the target position based on a condition that the agent does not exist in the control area which is not managed by the first local computing section, and transmits a determination result to another local computing section for the integrated control area; and
the another local computing section determines the moving route for the agent to be managed by the another local computing section on the assumption that the transmitted moving route exists.

4. The agent management system according to claim 1, wherein:
the local computing section determines the moving route in response to an instruction from a task management unit for managing the target position of the agent in the management area; and
upon updating of the target position of each agent, the task management unit preferentially allocates the target position in the control area where a target agent exists.

5. The agent management system according to claim 1, wherein:
the local computing section determiners the moving route in response to an instruction from a task management section for managing the target position of the agent in the management area; and
upon updating of the target position of each agent, the task management unit calculates a priority order of the control area through which the agent passes so as not to make the number of agents in each of the control areas beyond a throughput of the local computing section corresponding to the control area when allocating the target position that requires passage through a plurality of control areas.

6. The agent management system according to claim 1, wherein it is possible to change division into the control area in an optional timing so long as the number of agents beyond a throughput of the local computing section corresponding to the control area do not exist.

7. The agent management system according to claim 3, wherein a route planning is performed not to cause a direction change in the moving route at a boundary between the control area to be managed by the first local computing section and the control area to be managed by another local computing section.

8. An agent management method for determining a moving route for movement of an agent movable in a management area from an initial position to a target position, wherein
the management area is divided into a plurality of control areas, and a local computing section placed for each of the divided control areas determines the moving route for the agent in the control area, and gives the determined moving route to the agent.

9. The agent management method according to claim 8, the initial position of the agent and the target position of the agent being located in the different control areas, wherein:
among a plurality of local computing sections, a first local computing section for managing the initial position sets an integrated control area for integrating all control areas from the initial position to the target position, determines a moving route for each of all the agents in the control area of the integrated control area, which is managed by the first local computing section, sets the moving route from the initial position to the target position based on a condition that the agent does not exist in the control area which is not managed by the first local computing section, and transmits a determination result to another local computing section for the integrated control area; and
the another local computing section determines the moving route for the agent to be managed by the another local computing section on the assumption that the transmitted moving route exists.
